(19) United States
(12) Patent Application Publication
(10) Pub. No.: US 2011/0311775 A1
(43) Pub. Date: Dec. 22, 2011

(54) Constructional element, and a method for producing the element

(75) Inventor: Roger Ericsson, Sundyberg (SE)

(73) Assignee: Givent Ltd., Msida (MT)

(21) Appl. No.: 13/138,497

(22) PCT Filed: Mar. 1, 2010
(86) PCT No.: PCT/SE2010/000046

§ 371 Date: Aug. 26, 2011

(30) Foreign Application Priority Data
Feb. 27, 2009 (SE) 0900257-7

(51) Int. Cl. B32B 3/00; B29C 39/10

(52) U.S. Cl. 428/156; 264/263

(57) ABSTRACT

At least one embodiment of the present invention relates to a constructional element for use in building structures. In at least one embodiment, the element includes a least a first and a second side extending substantially parallel to each other and includes: a continuous board; a continuous insulating layer with substantially the same size as the board, the insulating layer is aligning, and bounded to, one side of the board; a first and a second load bearing beam of high performance concrete extending along the first and second side; at least one elongated load bearing element of high performance concrete extending between the first and second load bearing beam; wherein the elongated load bearing element and the first and second load bearing beam are extending in grooves in the side of the insulating layer facing away from the board, the load bearing element, and first and second load bearing beams are separated from the board.

### TECHNICAL FIELD OF THE INVENTION

The present invention relates to a constructional element, a building comprising said element and a method for producing the element.

### BACKGROUND OF THE INVENTION

Almost all building structures for use within a number of different fields, like for example buildings, comprises some type of constructional elements for use as walls, roofs or similar.

There are a number of different types of prefabricated structures that are used for this purpose and they all have some severe problems in common. First, they all have quality problems since they do not fulfil the demands regarding tolerances and appearance since the dimensions of the final wall elements as well as the surface conditions differs a lot. Secondly, all these prefabricated elements are heavy in relation to their dimensions which make the transport and installation of the elements in the framework structure complicated, time consuming and in the end expensive.

There is consequently a need for a prefabricated constructional element with the required quality and that could be produced within the desired tolerance to a reasonable cost.

### SUMMARY OF THE INVENTION

The present invention, defined in independent claim 1 fulfils the needs described above.

The constructional element for use in building structures has a least a first and a second side extending substantially parallel to each other. The element comprises:
a continuous board;
a continuous insulating layer with substantially the same size as the board, said insulating layer is aligning, and bounded to, one side of the board;
a first and a second load bearing beam of high performance concrete extending along said first and second side;
at least one elongated load bearing element of high performance concrete extending transversely between said first and second load bearing beam; wherein
   said elongated load bearing element and said first and second load bearing beam are extending in grooves in the side of the insulating layer facing away from the board, said load bearing element, and first and second load bearing beams are separated from the board.

The element according to the invention provides a very strong and light element that could be prefabricated to the desired tolerances. This is possible since the load bearing elements in combination with the first and second load bearing beam provide the desired structural strength that makes it possible to reduce the amount of material in the board.

One essential feature in the element according to the invention is the use of high performance concrete in the load bearing elements. The high performance concrete differs from conventional ordinary concrete in that it has a higher compressive strength. The compressive strength for high performance concrete is above 80 MPa. Furthermore, the water/concrete ratio for the concrete paste should be less than 0.39. This ration ensures that the amount of water is sufficiently low in relation to the amount of concrete to reach the desired strength. The specified high performance concrete has several advantageous properties such as almost no shrinking during curing, no creep over time, etc. The fact that almost no shrinking takes place during curing of the concrete is very important to ensure the high quality and narrow tolerance of the element

The element according to the invention could be prefabricated in a separate plant to reduce the amount of work that has to be done at the constructional work place which saves time. Furthermore the element reduces the element weight which also will have a positive impact on the building cost since the reduced weight will make it possible to reduce the amount of reinforcements and material in the building framework and several thereto related structures. All these aspects in combination with the reduced cost for transports and handling of the elements will in the end reduce the building cost considerably.

In one embodiment of the constructional element, the continuous board is made of concrete, plywood, plastic or gips. By selecting the board material and surface properties the board could be pre-produced to a higher degree and reduce the work that otherwise has to be done to reach the desired appearance and tolerance of the element.

In one embodiment of the constructional element, the board has a thickness of at least 5 mm, and preferably above 10 mm. In order to be able to produce the element to an acceptable cost and reach the desired element strength the board has to be at least 5 mm. However, if the board should be able to bear loads, the thickness must be increased to up to about 60 mm.

In one embodiment of the constructional element, the groove has a depth of at least 30 mm and a width of at least 10 mm. This embodiment ensures that the load bearing elements will have the desired strength and could be produced to a reasonable cost.

In one embodiment of the constructional element, the load bearing element is made of high performance concrete reinforced with non-metal fibres. The use of fibre-reinforced concrete provides load bearing elements with sufficient strength that are easy to manufacture.

In one embodiment of the constructional element, the load bearing element and/or the load bearing beams comprise at least one elongated iron reinforcement bar. The iron reinforcement bar is one reliably solution for ensuring an element with the desired structural strength.

In one embodiment of the constructional element, the insulating layer is made of cellular plastic. This material does have a comparatively low cost and provides a strong adhesion to the board. Furthermore it is fairly easy to form the groove, or grooves, in the cellular plastic.

In one embodiment of the constructional element, the insulating layer comprises more than one layer of insulating material and one layer is made of cellular plastic. The insulating layer could comprise layers of different insulating materials in order to adapt the element for use within different structures where the needs vary. The element could for example be made with high thermal or sound insulation properties. However, the element still comprises a layer of cellular plastic to facilitate the formation of the groove as well as the casting of the load bearing elements in the grooves.

In one embodiment of the constructional element, a second continuous board is arranged on the opposite side of the insulating layer in relation to the continuous board. This embodiment of the element provides an element that is even more possible to pre-fabricate since also the opposite side of the element could be finished with a desired surface which will also help reducing the required building time.

In one embodiment of the constructional element, the second board is made of high performance concrete and formed integrated with the load bearing elements and the load bearing beams. This embodiment provides an element with a very high strength in relation to the element weight.

In one embodiment of the constructional element, the element comprises one or more openings. This embodiment is very favourable since the element could be prefabricated with openings used for example for windows.

In one embodiment of the constructional element, the element comprises one or more load bearing columns extending parallel to the load bearing element. The column, or columns, is formed of reinforced high performance concrete to be able to withstand higher loads than the load bearing elements.

The constructional element could for example be used in buildings wherein said element is used as a wall or roof. If the constructional element is used as an outer wall the board is preferably turned facing inwards, and if the board is used in a roof the board is preferably positioned facing outwards. The constructional element is one important component in the building of concrete buildings with low weight.

The invention furthermore relates to a method for producing a constructional element according to anyone of the embodiments described above. The method comprising the following steps:
a. position a board, or cast a board, in a horizontally placed mould;
b. arranging the insulating layer with the prefabricated grooves on the upper surface of the board;
c. pouring a high performance concrete in the groove, or grooves, to cast the elongated load bearding element;
d. curing the high performance concrete; and
e. removing the element from the mould;

The claimed method provides a very efficient method for preproduction of the constructional element according to the invention. The method ensures a high quality of the final product that could be produced efficiently indoors in a production plant.

In one embodiment of the method, the method further comprises the step of providing further high performance concrete and cast a second board on top of the insulating layer before the curing of the concrete is initiated. This embodiment is advantageous if a continuous board is desired on both sides of the element.

One embodiment of the method, the method further comprises the step of arranging at least one reinforcement bar within the recess before the concrete is added.

Different embodiments of the element and the method for producing said element could of course be combined without departing from the scope of the invention. Further advantages and details of the invention will be recognised in the detailed description.

### BRIEF DESCRIPTION OF THE DRAWINGS

Different embodiments of the present invention are illustrated in the appended drawings, in which:

FIGS. 1, 2 and 3 illustrates cross-sectional views of different embodiments of insulating layers.

FIG. 4 illustrates a vertical cross section of an insulating layer.

FIG. 5 illustrates a front view of an insulating layer for use in a wall element.

FIG. 6 illustrates a horizontal cross sectional view of the wall element in FIG. 5.

FIG. 7 illustrates a horizontal cross sectional view of a second embodiment of a constructional element.

FIG. 8 illustrates a horizontal cross sectional view of a board and insulating layer intended to comprise a load bearing column.

FIGS. 9, 10 and 11 illustrates different vertical cross sections through a constructional wall element.

FIG. 12 Discloses a schematic illustration of a constructional wall element mounted in a building framework.

FIG. 13 illustrates a further embodiment of a constructional element according to the invention.

### DETAILED DESCRIPTION

A first embodiment of the constructional element 10 according to the invention will now be described in detail with reference initially to FIG. 6. FIG. 6 illustrates a horizontal cross-section through a first embodiment of the constructional element. The element 10 comprises a continuous board 11, an insulating layer 12, a number of elongated load bearing elements 13, a load bearing column 14 and opening closures 15.

The board 11 preferably has a substantially constant thickness, but could also be designed with different thickness within different sections of the element in order to save material and weight in areas where the loads on the board are limited. The board thickness, and the material of the board, is determined from the expected load on the element and the intended use of the element. The board thickness should preferably be kept as small as possible to reduce the amount of heavy and costly material in the board as well as the overall weight of the constructional element. The board material could for example be reinforced concrete, plywood etc depending on the intended use of the element.

The insulating layer 12, illustrated more in detail in FIGS. 1 to 3, is aligning and bounded to one side of the board 11. The insulating layer could for example be bounded to the board by a adhesive that provide a bounding with sufficient strength to maintain the insulating layer in the intended position in relation to the board. In order to facilitate the bounding of the insulating layer to the board the contact surface 16 of the insulating layer 12 could have different structure.

The insulting layer either consist of one layer, or several different layers that are selected to provide a constructional element with specific properties regarding for example thermal insulation or sound. The insulating layer could be made of several different materials, or a combination of materials like cellular plastic. The cellular plastic has some advantages compared to many other materials in that it makes it possible to generate the grooves that will be explained later on in an easy way.

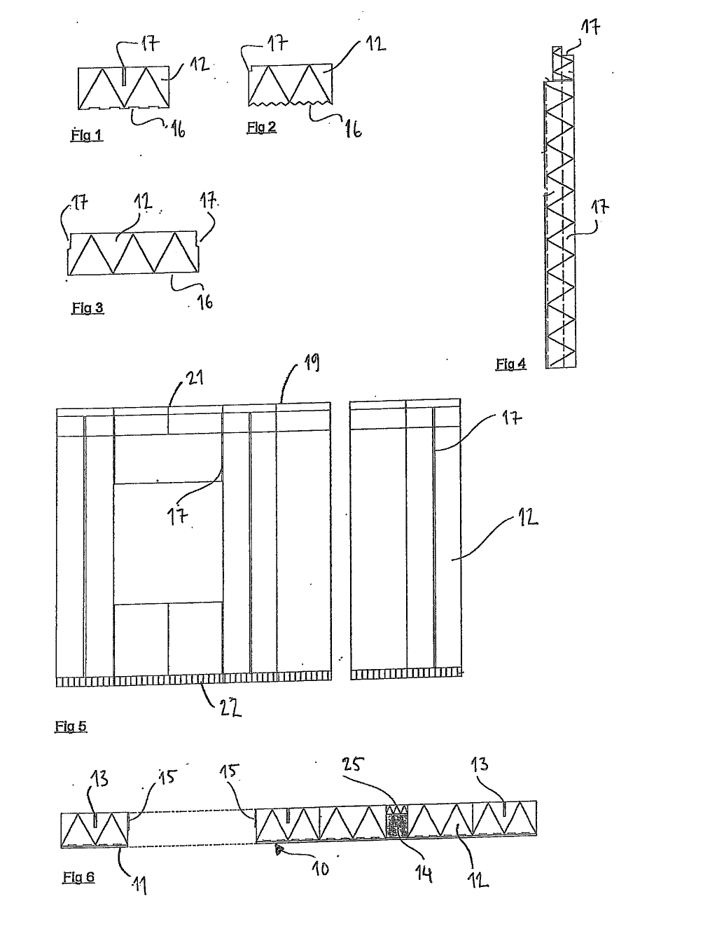

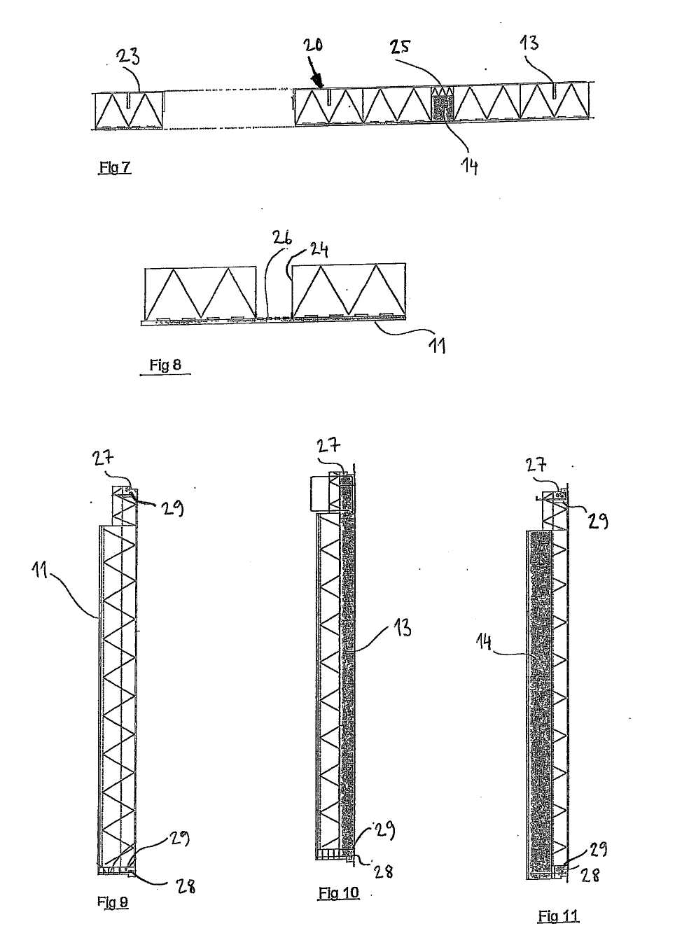

In the opposite side of the insulating layer, FIG. 6, grooves 17 are arranged in the insulating layer 12. The grooves 17 are intended for forming the load bearing elements 13 and are substantially straight and extend in the same longitudinal direction at predetermined distanced from each other across the surface of the insulating layer, illustrated in FIG. 5. The grooves 17 are separated from the board 11 and do not extend all the way through the insulating layer 12 to the surface of the board 11.

In the grooves 17, a load bearing element 13 is arranged in order to provide the desired structural strength of the constructional element 10. The load bearing elements 13 are in the embodiment in FIG. 5 extending in vertical direction to support the vertical loads that are present in buildings as well as provide the required stability to the element in order to make it possible to withstand the loads from for example the wind. However, load bearing elements could also be arranged extending in horizontal direction to generate a grid-shaped supporting framework and increase the strength of the constructional element further.

The width and depth of the grooves 17 are selected in order to ensure that the load bearing element 13, and consequently the constructional element 10 will have the desired strength. The elongated load bearing elements 17 in the grooves are made of high performance concrete. To ensure the desired strength of the load bearing elements, the load bearing elements preferably are provided with at least one reinforcement bar, not illustrated, that extends within the groove.

In order to facilitate the installation work of the constructional element 10, electrical cables could be lead through the grooves 17 in the insulating layer 12 as long as the remaining area of the groove provides the desired element strength.

FIG. 5 discloses an insulating layer for a constructional wall element 19 to be formed by the constructional element of the invention. The wall element has a substantially rectangular shape with a first 21 and second 22 side extending in horizontal direction. The load bearing elements 17 extend in vertical direction, substantially transverse to the first 21 and second side 22 of the wall element 19.

In FIG. 7, a second embodiment of constructional element 20 is illustrated. The difference between this and the previous embodiment is that the element comprises a second board 23 placed on the opposite side of the insulating layer 12. This embodiment of the constructional element provides an element with a continuous layer on both sides of the intermediate insulating layer.

In the embodiments 10; 20 illustrated in FIGS. 6 and 7, a load bearing column 14 is illustrated. The load bearing column has a considerably larger cross sectional area compared to the elongated long bearing elements in order to be able to bear a larger load. The load bearing column 14 is arranged in contact with the first board 11 in contrast to the load bearing elements that are arranged on the opposite side of the insulating layer separated from the board.

The load bearing column 14 is produced by dividing the insulating layer 12 and generating a gap 24 between two sections of the insulating layer positioned adjacent to each other, illustrated in FIG. 8. Reinforcement bars are positioned within the gap before concrete is poured in the mould to cast the column. The columns are in use arranged in vertical directions within the building to assist as one component in the building framework. The column 14 preferably has a slightly smaller width than the insulating layer 12 and will thereby not extend all the way to the surface of the insulating layer. In order to not have a negative impact on the thermal insulation of the constructional element the space between the column and the surface of the insulating layer is filled by an insulating material 25. To avoid that concrete penetrates between the insulating layer and the surface of the board 11, a U-shaped metal profile 26 could be arranged in the lower part of the gap 24.

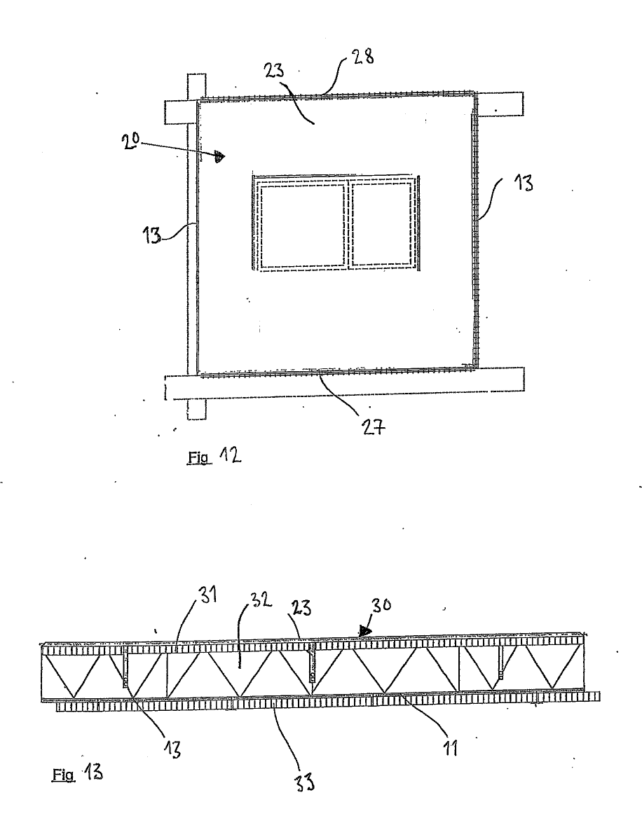

In FIGS. 9, 10 and 11 vertical cross sections though a constructional element 20 are illustrated. In these figures a first 27 and second 28 load bearing beam extending in horizontal direction along the top 21 and bottom side 22 of the element 10 are illustrated. These beams are connected to the load bearing elements 13, illustrated in FIG. 10, to provide a stiff framework around the constructional element 10. This framework is very important to provide the desired element strength that is needed to be able to transport and handle the element prior to mounting within the building framework. Additional grooves 29 are extending along the edge of the first and second side of the insulating layer 12 in order to, in combination with the mould, form the first 27 and second 28 load bearing beams.

Furthermore, the constructional element is around the edge designed to match the framework in which it is intended to be mounted. The final securing of each element could be done in many different ways depending on the specific use and design of the element and the building.

The present constructional element 10, 20, is produced by the claimed method comprising the following steps:
a. position a board 11, or cast a board 11, in a horizontally placed mould;
b. arranging the insulating layer 12 with the prefabricated grooves 17 on the upper surface of the board 11;
c. pouring a high performance concrete in the groove 17, 24, 29, or grooves 17, 24, 29, to cast the elongated load bearding element 17 and the load bearing beams 27, 28;
d. curing the high performance concrete; and
e. removing the element 10, 20 from the mould;

This method for producing the constructional element makes it possible to pre-produce the elements in an efficient way to a reasonable cost since the load bearing elements 17 and beams 27, 28 are formed in one step by pouring the concrete into the mould where the insulating layer 12, in combination with an external mould is used for forming the supporting structure of the element.

In the embodiment of the board containing a second board 23, this second board 23 is preferably formed by using the claimed method and in step c. pouring a larger amount of high performance concrete into the mould so that the grooves 17, 27, 28 in the insulating layer 12 are filled by concrete and the entire insulated layer covered by concrete to form the second board 23 on top of the insulating layer.

As can be seen in FIG. 5, the constructional element could be provided with openings for windows and doors. To avoid that the insulating layer is exposed in the opening, this could be prevented by the claimed method. This is prevented by designing the mould so that a small recess is formed between the insulating layer and the surface of an edge of the mould that is positioned in the area of the intended opening. This means that the edge of the insulating layer at the same step as the concrete is added in the grooves in the insulating layer will be covered by high performance concrete.

In FIG. 12, a constructional wall element is disclosed schematically to facilitate understanding of the use of the constructional element of the invention.

In FIG. 13 a further embodiment of a constructional element 30 according to the invention is illustrated. This element furthermore comprises an insulating layer divided into two different layers 31, 32, and furthermore a second insulating layer 33 positioned on the side of the board facing away from the insulating layer. This second insulating layers 33 provides an element with high sound damping properties.

While some presently preferred embodiment of the invention has been described herein, it is to be understood that these embodiments could be combined in any suitably way without departing from the scope of the invention. The invention is not limited to the disclosed embodiments but covers and includes any and all modifications and variations that are encompassed by the following claims.

1. Constructional element for use in building structures, said element including at least a first and a second side extending substantially parallel to each other, the constructional element comprising:
a continuous board;
a continuous insulating layer, substantially the same size as the board, said continuous insulating layer being aligning, and being bounded to one side of the board;
a first and a second load bearing beam of high performance concrete respectively extending along said first and second side;
at least one elongated load bearing element of high performance concrete extending transversely between said first and second load bearing beam, wherein
said at least one elongated load bearing element and said first and second load bearing beam are extending in grooves in the side of the insulating layer facing away from the board, said load bearing element, and first and second load bearing beams being separated from the board.

2. Constructional element according to claim 1, wherein the continuous board is made of high performance concrete, plywood, plastic or gips.

3. Constructional element according to claim 1, wherein the board has a thickness of at least 5 mm.

4. Constructional element according to claim 1, wherein the groove includes a depth of at least 30 mm and a width of at least 10 mm.

5. Constructional element according to claim 1, wherein at least one of the load bearing element and the load bearing beams is made of high performance concrete reinforced with non-metal fibres.

6. Constructional element according to claim 1, wherein at least one of the load bearing element and the load bearing beams comprises at least one elongated iron reinforcement bar.

7. Constructional element according to claim 1, wherein the insulating layer is made of cellular plastic.

8. Constructional element according to claim 1, wherein the insulating layer comprises more than one layer of insulating material and wherein one layer is made of cellular plastic.

9. Constructional element according to claim 1, wherein a second continuous board is arranged on the opposite side of the insulating layer in relation to the continuous board.

10. Constructional element according to claim 9, wherein the second board is made of high performance concrete and formed integrated with the load bearing elements and beams.

11. Constructional element according to claim 1, wherein said element comprises one or more openings.

12. Constructional element according to claim 1, wherein said element comprises one or more load bearing columns extending parallel to the load bearing element.

13. Building comprising at least one constructional element according to claim 1, wherein said at least one constructional element is used as a wall or roof.

14. Method for producing a constructional element, said method comprising:
positioning a board, or casting a board, in a horizontally placed mould;
arranging an insulating layer with prefabricated grooves on an upper surface of the board;
pouring a high performance concrete in at least one of the grooves, to cast the elongated load bearding element, and the first and second load bearing beams;
curing the high performance concrete; and
removing the constructional element from the mould.

15. Method for producing a constructional element according to claim 14, further comprising:
providing further high performance concrete; and
casting a second board on top of the insulating layer before the curing of the concrete is initiated.

16. Method for producing a constructional element according to claim 14, further comprising:
arranging at least one reinforcement bar within the grooves before the concrete is added.

17. Constructional element according to claim 3, wherein the board has a thickness of at least 10 mm.
